(19) United States
(12) Patent Application Publication
(10) Pub. No.: US 2006/0090649 A1
(43) Pub. Date: May 4, 2006

(54) High separation area membrane module

(76) Inventors: Wei Liu, Painted Post, NY (US); Jimmie L. Williams, Painted Post, NY (US)

Correspondence Address: CORNING INCORPORATED, SP-TI-3-1, CORNING, NY, 14831, US

(21) Appl. No.: 10/978,126

(22) Filed: Oct. 29, 2004

(51) Int. Cl. B01D 53/22

(52) U.S. Cl. 96/4

(57) ABSTRACT

A ceramic monolithic multi-channel module support (10) has a module hydraulic diameter (102) in a range about 9 to 100 mm, an aspect ratio of the module hydraulic diameter (102) to a module length (104) greater than 1, a plurality of feed flow channels (110) distributed substantially in parallel over a module cross-section, the plurality of feed flow channels (110) having a size and shape defining a channel density in the range of about 50-800 channels/in² (7.8-124 channels/cm²) in a module frontal area, a channel hydraulic diameter (112) in the range of about 0.5-3 mm, a rim distance (120) having a thickness greater than 1.0 mm (0.04 in), and a percent open frontal area (OFA) in the range of about 20-80%.

### BACKGROUND OF THE INVENTION

1. Field of the Invention

The present invention relates generally to membrane separation, and particularly to membraned supports for separation.

2. Technical Background

Purified gas/vapor or liquid from a mixed feedstream of different gas and/or liquid combinations is required in various applications. For example, as one example out of many, purified hydrogen is used in the manufacture of many products including metals, edible fats and oils, and semiconductors and microelectronics. Purified hydrogen is also an important fuel source for many energy conversion devices. For example, fuel cells use purified hydrogen and an oxidant to produce an electrical potential. Various known processes and devices may be used to produce the hydrogen gas that is consumed by the fuel cells. However, many hydrogen-production processes produce an impure hydrogen stream, which may also be referred to as a mixed gas stream that contains hydrogen gas. Prior to delivering this stream to a fuel cell, a stack of fuel cells, or another hydrogen-consuming device, the mixed gas stream needs to be purified, such as to remove undesirable impurities.

Membrane separation process is generally more energy efficient and easier to operate than other separation processes. In particular, inorganic membranes, such as, Palladium (Pd), Pd-alloy, zeolites, alumina, SiC, silica, etc., are suitable for the separation of hydrogen at high temperature and high pressure, because they can be operated under more severe conditions compared to polymer membranes.

Hydrogen-selective membranes formed from hydrogen-permeable metals, most notably palladium and alloys of palladium, are known. In particular, planar palladium-alloy membranes have been disclosed for purifying hydrogen gas streams, such as hydrogen gas streams produced by steam reformers, autothermal reformers, partial oxidation reactors, pyrolysis reactors and other fuel processors, including fuel processors configured to supply purified hydrogen to fuel cells or other processes requiring high-purity hydrogen. Palladium-based membranes have exceptionally high selectivity to hydrogen permeation over other molecules (CO, CO₂, H₂O, N₂, CH₄, etc.). The purified hydrogen is directly suitable for use in fuel cells and no further purification is needed. For example, hydrogen with a very low carbon monoxide content is needed for fuel cells (typically less than 100 ppm for low-temperature phosphoric acid fuel cells and less than 10 ppm for proton exchange membrane fuel cells). Theoretically, the Pd membrane does not allow CO to go through. By eliminating defects or pinholes on the membrane, a high purity hydrogen gas stream can be obtained. The Pd membrane operates at moderately high temperatures (>300° C.) and high pressures. These conditions are compatible with the process conditions of hydrogen-containing gas mixtures generated from catalytic reforming reaction units. Further more, the Pd membrane works under the reforming reaction conditions (steam reforming or water-gas-shift reaction) so that the membrane separation process can be combined with the reaction process in the same apparatus, that is, a membrane reactor is feasible for one possible use of a membraned support.

It is known that an increase in surface area of a monolithic membrane support is desired, along with high permeability, minimum fouling, and strong mechanical strength or integrity. However, the balance of requirements for material processing of the support is not known yet, along with quality membrane coating inside the channels of the monolithic membrane support. The teachings of the present invention provide a solution to overcome the complex module design problems that precipitate the inventive module support.

### SUMMARY OF THE INVENTION

One aspect of the invention is a ceramic monolithic multi-channel module support having a module hydraulic diameter in a range about 9 to 100 mm, an aspect ratio of the module hydraulic diameter to a module length greater than 1, a plurality of feed flow channels distributed substantially in parallel over a module cross-section, the plurality of feed flow channels having a size and shape defining a channel density in the range of about 50-800 channels/in² (7.8-124 channels/cm²) in a module frontal area, a channel hydraulic diameter in the range of about 0.5-3 mm, a rim distance having a thickness greater than 1.0 mm (0.04 in), and a percent open frontal area (OFA) in the range of about 20-80%. For compatibility with desired geometries, the support matrix preferably has an average pore size of about 0.5 to about 20 μm, and porosity of about 0.25 to about 0.75. A networked pore structure in the support matrix is also preferred.

In another aspect, the present invention includes a membrane film disposed on the inner surfaces of the plurality of feed flow channels, wherein the membrane film is a member selected from the group consisting of palladium, palladium-alloy, Pd—Ag, Pd—Cu, zeolite, alumina, zirconia, silica, SiC, glass, and polymer.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawing illustrate various aspects of the invention, and together with the description serve to explain the principles and operations of the invention.

### BRIEF DESCRIPTION OF THE DRAWINGS

FIG. 1 is a perspective view of one embodiment of the present invention.

### DETAILED DESCRIPTION OF THE PREFERRED EMBODIMENTS

As use for a membrane on a membrane support, palladium alloy may be deposited on the porous support at desirable thicknesses using a variety of methods, of which sputtering, chemical vapor deposition, physical vapor deposition and electroless plating are examples. Thus, the Pd membrane represents a fairly good example of dense membranes for gas separation. The dense membrane means that there is no porous structure inside the membrane.

Another category of important membrane examples is micro-porous membranes with pore size of 2 nm or less. The microporous membranes are used for separation of liquid or gas streams largely based on molecular sizes. Zeolites are a class of effective materials representative of microporous membranes. The zeolite material has well-defined pore structures and proved functions as catalytic and adsorbent materials in refining, petrochemical, chemical, and gas processing industries. For gas separation over the microporous membranes, such as hydrogen gas mixture separation over MFI-type zeolite membrane at high temperatures (>200° C.), the molecules larger than the zeolite pore size are blocked, even for the molecules less than the pore size, the smaller size molecule (H₂) moves faster through the pore than the larger molecules (e.g., CO₂). As a result, the purity or concentration of the smaller molecules in the permeate is much higher than that in the feed gas. For liquid-separation over the microporous membrane, such as protein/water separation, the larger protein molecules are blocked, while the smaller solvent molecules such as water permeates through the pore. Thus, the microporous membrane is useful for both gas separation and liquid separation.

For the dense or microporous membrane, the membrane layer imposes a high resistance because of its “tightness”. Transport resistance is generally meant to be the pressure drop across a given length at a given flux. Flux of the smaller molecule through the membrane is inversely proportional to the membrane thickness. To be effective for a practical separation process, the membrane must be very thin, preferably less than 10 μm, in order to have the target flux at the pressure drop level that is economical. For example, the pressure drop could be 5 to 25 bar for hydrogen gas separation, and may be 0.5 to 10 bar for the liquid-phase filtration. Obviously, such a thin membrane is too weak to support itself and it must be applied onto a strong, porous support material.

On the other hand, the permeation rate is proportional to the membrane surface area. Permeability can be characterized with permeability coefficient. The permeability coefficient can be calculated from the pressure drop, transport length, and flux. Since we are dealing with the convection flow inside the support matrix, the permeability is not much affected by the diffusion. Instead, it is largely affected by the pore structure of the support and the fluid properties such as viscosity. However, for the permeability through the membrane layer, the diffusivity is an important factor.

To have a high permeation throughput, the membrane surface area per unit volume should be as high as possible. In addition, the support material must be stable chemically and mechanically under the separation conditions in the presence of the separation mixture. Thus, the membrane support is critical for the membrane separation process. The specific surface area for the membrane separation is defined in the following equation for the present discussion:
SA_{V}=[membrane surface area]/[volume of membrane module]
For the thin film membrane being supported on a membrane support, the membrane surface area is close to the membrane support surface area.
For example, for a tubular membrane with the membrane being coated on the outer surface, the tube outer diameter is dt. Then, the specific surface area is:

$${SA}_{V} = \frac{π {d}_{t} h}{\frac{π {d}_{t}^{2}}{4} \cdot h} = \frac{4}{{d}_{t}}$$

where h is the length and dt is the tube outer diameter (OD).

Porous stainless steel and alumina in a tubular form is often used as the membrane support. In a tubular membrane separation, the feed mixture is allowed to pass through the tube side, part of the feed (often as the desired product stream of smaller molecular sizes) permeates through the membrane layer coated on the wall and is withdrawn from the shell side, while another part of the feed that is retained by the membrane layer flows out from another end of the tube. A positive pressure gradient is maintained between the tube and shell side to drive the permeation through the membrane layer and the support wall. The tubular membrane can also be operated in a configuration where the membrane layer coated on the external surface of the tube, the feed mixture is introduced from the shell side, and the permeate is withdrawn from the tube side.

The perceived main advantages with the stainless steel membrane support are (1) its easy connectivity with each other and (2) its flexibility. For example, the tube can be bent to the form of a continuous zigzag or other convoluted or similar configuration so that a long membrane tube could be housed inside a short membrane vessel. However, there are several shortcomings with the stainless steel support. As a Pd-membrane support, the stainless steel can react with the Pd membrane that reduces the membrane flux and creates the membrane defects. As a result, a ceramic oxide barrier layer is applied between the Pd membrane film and the stainless steel support. As a support for ceramic microporous membranes such as zeolite, the steel does not have a good chemical and/or mechanical compatibility with the membrane material. Furthermore, the pore structure of the stainless steel support is not stable at elevated temperatures, which results in degradation of the membrane performance with time.

Ceramic tubes such as alumina are commonly used ceramic membrane supports. The ceramic tubes have better chemical and thermal stability than stainless steel. But, ceramic tubes are perceived as fragile, particularly with small diameters of the tubes.

In a module for use in separation or filtration processes using tubular membranes, the dimension and configuration of the membrane body is chosen so that the optimum performance can be achieved. For a tubular membrane, the larger the diameter of the tube, the stronger the tube is and a longer length can be made. However, the larger the diameter of the tube, the smaller surface area per unit volume of the tube so that a larger membrane vessel size is needed. The separation surface area per unit volume (or packing density) is an important factor that determines the membrane unit throughput and process economics. In addition to packing density, the tube diameter also affects the mass transfer between the wall surface and bulk fluid in the tube. The larger the diameter, the slower the mass transfer rate is. For the gas separation process, the diffusional mass transfer is fast and the mass transfer may not be a major factor. For the liquid-phase separation, however, the diffusion rate is nearly four to five orders of magnitude lower than that in the gas phase, the mass transfer may become a significant factor. Furthermore, the tube diameter affects the wall thickness that is required to withstand the designed pressure gradient across the wall. The larger the diameter the tube is, the thicker the wall is needed. The thick wall increases the resistance for the permeate to go through the wall and thus, reduces the flux at a given pressure gradient.

The smaller tube diameter is desired to have a higher separation surface area, less mass transfer resistance inside the channel, a thinner wall and a higher flux. However, the smaller tube is generally more difficult to make. Particularly, small diameters of ceramic tubes are fairly fragile. Particularly, using smaller diameters of tubes increases number of the membrane tubes to be assembled, and results in a high cost of module system engineering.

Thus, the tubular membrane presents a dilemma in balancing the membrane performance and module system engineering.

To cope with the above problems, multi-channel membrane module designs have been proposed . . . The multi-channel module generally has a monolithic structure comprising a number of parallel membrane channels in one module body. In other words, a plurality of tubes is bounded together with a porous matrix.

This kind of module design significantly increases the technical complexity, compared to the single-channel tubular membrane. Channel size, channel density, channel shape, module diameter, module length, pore size and porosity of the module matrix need to be all balanced and optimized to achieve optimum membrane flux, maintain mechanical strength, enhance mass transfer, and reduce fouling.

Hence, a suitable membrane support/module design is a major factor that enables both high surface area and high flux, as a solution to very challenging material processing problems. The membrane supports, as taught by the present invention, includes ceramic, monolithic structures of the right channel geometry, pore size, and porosity with a high separation surface area to provide an inventive balance of high gas permeability and high mechanical strength.

Reference will now be made in detail to the present preferred embodiments of the invention, an example of which is illustrated in the accompanying drawings. Whenever possible, the same reference numerals will be used throughout the drawings to refer to the same or like parts.

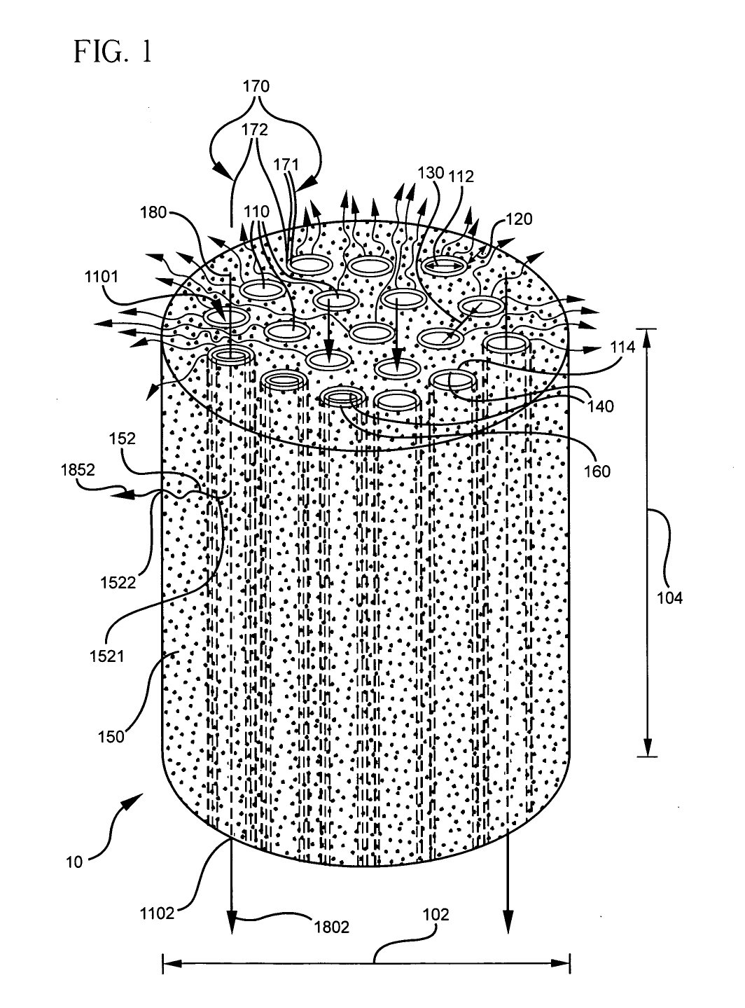

Referring to FIG. 1, a ceramic monolithic multi-channel module support 10 has a module hydraulic diameter 102 in a range about 9 to 100 mm, an aspect ratio of the module hydraulic diameter 102 to a module length 104 greater than 1, a plurality of feed flow channels 110 distributed in parallel over a module cross-section, the plurality of feed flow channels 110 having a size and shape defining a channel density in the range of about 50-800 channels/in² (7.8-124 channels/cm²) in a module frontal area, a channel hydraulic diameter 112 in the range of about 0.5-3 mm, a rim distance 120 having a thickness greater than 1.0 mm (0.04 in), and a percent open frontal area (OFA) in the range of about 20-80%.

By definition, the average hydraulic diameter (Dₕ) is defined by the following formula:
Dₕ=4(cross-sectional area/wetted perimeter).

Thus, for a two-dimensional shape, the hydraulic diameter of is 4 times the surface area divided by the perimeter. For example, for a circle of diameter d, the hydraulic diameter Dₕ=4[(πd²/4)]/(πd)=d. However, for a square of length L, hydraulic diameter Dₕ=4×L²/(4 L)=L. In general, a hydraulic diameter bears an inverse relationship to surface to volume ratio.

The module frontal area is the cross-sectional area of the module body that includes the solid matrix of porous material and channels. For example, for a cylindrical module of diameter d, the area is πd²/4. The open frontal area fraction is then the ratio of overall open channel areas to the module area. For example, for a module of cross-sectional area of 10 cm², if the total channel area is 5 cm², then the open frontal area fraction is 5/10=0.5 where the open channel area is the sum of cross-sectional areas for all of the channels. Even though the module 10 is shown as a cylinder is shown with a circular cross-section, the module can be of any shape, such as an elongated cube having a square, hexagonal or rectangular cross-section.

Preferably, the module hydraulic diameter 102 is in a range about 10 to 50 mm. The aspect ratio of the module hydraulic diameter 102 to a module length 104 greater than a range about 5-10. The plurality of feed flow channels 110 preferably has a channel density in the range of about 50-600 channels/in² (7.8-94 channels/cm²) in the module frontal area, a channel hydraulic diameter 112 in the range of about 0.5-2 mm, a web thickness between channel walls less than the rim distance 120 in a range about 0.2 to 5 mm (0.01 to 0.2 in), and a percent open frontal area (OFA) in a range about 30-60%, and specifically about 40%. The optimized module design thus offers a high separation surface area by using small-size flow channels 110 and a thin web thickness 130.

The channels are preferably distributed over the module cross-section symmetrically but may not need to be distributed uniformly. Even though the channel distribution is shown uniform in FIG. 1, the feed channels 110 can be distributed within the module in non-uniform ways, as long as a substantial parallel distribution is maintained. However, if there is sufficient web thickness where there would not be an overlap or intersection of non-aligned channels, the channels 110 can even be skewed (having a skewed angle less than 90°) in a non-parallel distribution. For a non-uniform channel distribution, the web thickness 130 will be in a range of different thicknesses (about 0.2 to about 2 mm). But, it is preferred to have an adequate of skin thickness (e.g., >1 mm or 0.04 inch) in the rim 120 greater than the web thickness 130. The skin or rim thickness 120 is an independent parameter from the web thickness 130. The web thickness 130 basically determines how far the channels 110 are located next to each other, while the skin or rim thickness 120 affects the overall module strength and permeability.

Hence, the present invention teaches a high-surface area, monolith-structured inorganic tubular module having a porous body portion for supporting membrane that can be used for processing gas or liquids, such as hydrogen separation and/or purification. As one example, the monolith-structured membrane module is in the shape of a module tube having a module hydraulic diameter 102 preferably in a range of about 10˜30 mm. With this module hydraulic diameter 102, the module length 104 is substantially equal to the length of each of the plurality of feed flow channels 110 being in a range about 100-3000 mm for a high aspect ratio.

As a body portion 150 of the support, the ceramic monolithic matrix has a pore size in a range of about 1-30 μm and porosity in a range of about 20-80% to provide a macro-porous ceramic matrix having a plurality of tortuous flow paths 152 through the pores. Preferably, the pore sizes are in a range such that more than 20% of the total pore volume has a pore size in a range about 0.5 to 25 μm. In this way, the porosity is defined separately from the pore size. Thus, the substrate 150 can have all kinds of pore sizes as long as a certain fraction of those pores are large enough to give a good permeability.

Thus by defining certain pore sizes, it is vital that the pores inside the matrix are interconnected to form pathways 152 for the permeate. The interconnected pore structure also provides mechanical strength for the membrane module. A networked pore structure means that pores are interconnected to each other to form the torturous paths 152. If there are a lot of pores inside the support matrix but they are not connected, the fluid cannot be pushed through and the support is not suitable for the membrane application. There is no good definition about the pore connectivity. However, the pore connectivity can be qualitatively analyzed by use of electron microscopy. Generally, if the pore size and porosity is large enough, the networked pore structure can be formed.

Pore size and porosity are numbers that can be quantified with accepted measurement methods and models. The pore size and porosity is typically measured by standardized techniques, such as mercury porosimetry and nitrogen adsorption. The pore size is calculated with well-accepted equations. There are all possible shapes for the pore opening. The calculated pore size is a number to characterize the opening (width) of these pores based on well-accepted model equations. However, there is not a good method to characterize the length of the pore.

“Connectivity” of those pores, although important is harder to quantify. However, for a material of the same pore size and porosity, connectivity is largely determined by the forming process of the membrane support. The substrate or body portion 150 may be prepared by using known extrusion methods of inorganic materials as the backbone or substrate material. The forming process already known gives the connectivity, such as the same processing methods to form Corning Incorporate's diesel particulate filters, such as by incorporation of graphite particles, CeraMem Corporation's reactive alumina monolith forming process, single-channel alumina tube, etc.

The material of the ceramic monolithic is made from a member selected from the group consisting of mullite (3Al₂O₃-2SiO₂), alumina (Al₂O₃), silica (SiO₂), cordierite (2MgO-2Al₂O₃-5SiO₂), silicon carbide (SiC), alumina-silica mixture, glasses, inorganic refractory and ductile metal oxides. Mullite is a metal oxide compound from Al₂O₃+SiO₂ with several other possible compositions with different ratios possible, as is known in material chemistry. Crystal shapes of mullite, as well as other materials in the membrane support body, can be in hollow tube, tube or needle-like forms of high aspect ratio (>5), or conventional crystal forms of low aspect ratio (0.5˜5), or a mixture of mullite crystals of high and low aspect ratio. Common crystal phases for the alumina compound Al₂O₃ are gamma (γ-alumina), theta, and alpha (α) where alpha-alumina (α-alumina) is typically more stable than the other phases. SiC is a silicon carbide compound which is a refractory non-oxide ceramic material having good chemical and physical stability. Vycor® glass, available from Corning Incorporated could also be used as the material for the body 150 of the support.

The body of the module has a plurality of elongated apertures to form a channeled portion including passageways, conduits, or channels for forming a predetermined number of small flow channels 110. In one example, the channel size or channel hydraulic diameter 112 is in a range of about 0.5 to 3 mm, while the channel density is about 50 to 400 cpsi (channels per square inch).

Channel shape is preferred to be circular or rounded, as shown. However, the substrate channel shape could be in other shapes that are continuous with no sharp corners, such as hexagons. Even if the channels are shaped in squares, the channel shape may be modified through a subsequent coating process. Pore size and porosity of the channel wall 114 as well as surface properties (such as, roughness, adhesion, etc.) can be modified by one or more intermediate coating layer(s).

A layer 160 of porous materials that have smaller pore sizes than the matrix may need to be coated onto the channel wall 114 of the substrate or matrix body portion 150. The coating layer 160 may have three functions: (1) modify the channel 110 shape and wall texture, such as, pore size, surface smoothness, etc., (2) strengthen the substrate 150, and (3) enhance the membrane deposition efficiency and adhesion. The coating layer 160 is about 10 to 200 μm in thickness and has a pore size from 2 nm to about 500 nm. Hence, one or more intermediate layer 160 is optionally disposed on the inner surfaces or walls 114 of the plurality of feed flow channels 110 to form a nano- or meso-porous layer (2 to 50 nm in pore size). The range of 0.5-50 μm is the thickness. Thus, the nano or meso porous layer 2-50 nm can be used by itself as the intermediate layer or extra layers can be used with the nano layer, together as the combined intermediate layer with a thickness of the intermediate layer 160 between 2-250 μm and a pore size of 2 nm-500 nm.

The intermediate layer 160 is preferably a member selected from the group consisting of alumina, silica, mullite, glass, zirconia, and a mixture thereof, with special preferences to alumina and silica. The coating layer 160 may be applied by the wet chemistry method such as the sol-gel process.

A membrane film 140 providing the separation function is further applied onto the optional intermediate coating layer 160 or directly on the inner surfaces or walls 114 of the plurality of feed flow channels 110 of the ceramic support 10. Preferably inorganic, the film 140 can be a dense layer such as palladium (Pd), a palladium-alloy such as Pd—Ag, or Pd—Cu, or a non-metallic dense film that allows permeation of certain molecules in a mixture, such as SiC, or glass. Preferably inorganic for particular applications, the film 140 can be a micro-porous layer (<5 nm) such as zeolite, zirconia, alumina, silica, or glass. The dense or microporous membranes provide separation function in the molecular size level. However, the ceramic membrane support 150 of the present invention can also be used as a support for polymeric membrane films, as the film 140.

In general, the teachings of the present invention relates to the membrane support 150, not about the membrane itself, hence any type of suitable membrane can be used. Moreover, the support 150 is ideally suitable for separation where the smaller sized molecules are separated from the larger sized molecules and permeate through the support matrix 150. Either Pd membrane (dense), microporous, or even polymeric membrane films can be deposited on the support. In general, some mid-layers are needed between the above-mentioned membrane film and the support.

The inventive use of the small-sized flow channels (<3 mm) 110 facilitates the deposition of the uniform thin membrane layer 140 and reduces thermal stresses due to the metallic layer/ceramic support interface at the inner surfaces or walls 114. By applying the membrane 140 onto the small size of the channel 110, for example having the channel hydraulic diameter 112 about 0.5˜2 mm, the thickness of the meso- (2˜50 nm) and microporous (<2 nm) membrane coating layers 160 and 140, respectively, can be reduced, the pressure drop through the modifying coating layer 160 could be reduced at the same flux rate, and some power consumption could be saved to provide a more productive and effective membraned module support 10. Thus, a thin membrane layer 140 of Pd—Cu alloy film (1˜5 μm) can be deposited on the walls 114 of such small and long channels (about 1˜2 mm channel hydraulic diameter×300˜1000 mm length, for example) by the use of an electronless plating method. The bare monolith substrate is first preferably modified with a meso- and nano-porous (2 nm˜50 nm) coating 160 prior to the Pd—Cu membrane 140 deposition.

Hence, for achieving high surface area, one exemplary monolithic membrane support 10 is targeted for greater than 100 cpsi (cells per square inch) cell density having small circular channels 110 of about ˜1 nm size in channel hydraulic diameter 112 to facilitate membrane coating 140. The module dimensions are targeted for about 10˜50 mm in module hydraulic diameter 102 and about 100˜1000 mm in length 104. Different extrusion materials such as cordierite, mullite, alpha-alumina, SiC, typically used in diesel particulate filtering monoliths are optimized for pore size, porosity, and pore connectivity to achieve high permeability and high strength at the same time in the substrate matrix 150. However, the channel configuration used for the membrane support is different from the monolith diesel particulate filter in the emission control application. The pressure difference for the membrane separation is substantially higher than that for the diesel particulate filtering.

Table 1 makes a comparison of the monolith support geometry to the conventional single-tube support. An enhancement in specific separation area by nearly one order of magnitude is possible with the monolithic membrane support.

TABLE 1
Design comparison of monolithic support
geometry to the tubular support in general

| | MONOLITHIC | Tubular |
|---|---|---|
| GEOMETRY | SUBSTRATE | substrate |
| Outer module hydraulic diameter, mm | 20 | 20 |
| Channel density, cpsi (#/in²) | 390 | na |
| Number of flow channels | 190 | 1 |
| Flow channel hydraulic diameter, mm | 1 | 10˜18 |
| Membrane coating | Interior channel | Outer surface |
| | wall | |
| Specific separation surface area, m² | 1900 | 200 |
| membrane/m³(module) | | |

The main advantage of the present invention is thus the high achievement of separation productivity. For the membrane separation process, the separation productivity is directly proportional to the surface area per unit of the membrane module volume. In addition, the durability of the membrane module 10 as taught by the present invention provides three technical improvements. First, the monolith-structured module has a high specific separation area so that the number of individual modules to be assembled together for practical use is reduced. This would significantly reduce the engineering cost and failure rate of the separation system. Second, the high-porosity substrate or monolithic material has a strong thermal-shock resistance, which is demonstrated in their application in automotive catalytic converter and diesel particulate filter substrates. Third, the use of small-sized flow channels (about 1 mm) 110 allows the deposition of a uniform thin membrane layer 140 and reduce thermal stresses due to the metallic layer/ceramic support interface. The wash-coating intermediate layer 160 re-enforces the porous substrate 150 and in turn, is stabilized by the porous substrate 150. Contrary to common perception, substrates 150 of higher porosity can have stronger mechanical strength than denser substrates. When a thin layer of Pd membrane 140 is deposited on the meso-/nano-porous intermediate coating layer 160, the membrane durability is mainly determined by the strength of the monolithic substrate 150 and coating 160. Thus, the stable, robust membrane support 10 as taught by the present invention would yield high durability.

The inventive membrane support can be used for separating, purifying, filtrating, or other processing functions for a variety of gas-phase and liquid-phase mixtures through a plurality of tortuous paths 152 through the matrix of the porous body portion 150 having a membraned end 1521 and a non-membraned porous body end 1522. In general, the concept of tortuosity, is defined as the difference between the length of a flow path which a given portion of a mixture (gaseous or fluids) will travel through the passage formed by the channel as a result of changes in direction of the channel and/or changes in channel cross-sectional area versus the length of the path traveled by a similar portion of the mixture in a channel of the same overall length without changes in direction or cross-sectional area, in other words, a straight channel of unaltered cross-sectional area. The deviations from a straight or linear path, of course, result in a longer or more tortuous path and the greater the deviations from a linear path the longer the traveled path will be.

The inventive membrane module 10 has a simple structure that can be placed vertically as shown, laid horizontally, in a slant, or aligned in any other position. Each of the feed flow channels 110 has a feed end 1101 and an exhaust end 1102. The membrane film 140 is supported and adapted to receive under a positive pressure gradient 170, an impure mixed feedstream 180 fed on the feed end 1101 of the plurality of feed flow channels 110. The membrane film 140 is adapted to process the impure mixed feedstream 180 into a purified permeate 1852 that is formed from a portion of the impure mixed feedstream 180 that passes through an outside surface of the membrane film 140 and into the plurality of tortuous paths 152 of the matrix of the body portion 150, entering the membraned end 1521 and exiting through the non-membraned porous body end 1522. A byproduct stream 1802 remains from a portion of the impure mixed feedstream 180 that does not pass through the membrane film 140 for exhausting through the exhaust end 1102 of the plurality of feed flow channels 110.

For a given separation process, the overall pressure difference or pressure gradient 170 between the feed and permeate side consists of a first pressure drop ΔP_{f,i} 171 across the membrane film 140 and coating layer 160, and a second pressure drop ΔP_{m,i} 172 through the support matrix 150, according to the following equation:
ΔPₒᵥₑᵣₐₗₗ=Pᵢₙ−Pₒᵤₜ=ΔP_{f,i}+ΔP_{m,i}

The membrane flux increases with the pressure gradient 170 across the membrane film 140 and coating layer 160:
Jᵢ=k·ΔΔP_{f,i}

For a given separation process, ΔPₒᵥₑᵣₐₗₗ is fixed, but the pressure drop ΔP_{m,i} 172 through the support matrix 150 needs to be as small as possible:
ΔP_{f,i}>>ΔP_{m,i}

Only when the pressure drop 172 through the matrix, ΔP_{m,i}, is small enough relative to the overall pressure drop 170, that the membraned channels 110 are fully utilized.

One critical problem for the usability of any membrane support is the performance of gas permeability through the matrix 150. In order to fully utilize the membrane surface area on the channel wall 114, resistance for a molecule, such as hydrogen gas, to permeate from the inner body 150 having the innermost channel 150 to the outside of the module 10 must be negligible relative to the resistance through the separation membrane 140. Otherwise, effectiveness of such a membrane module would be discounted.

$$Δ P = L \cdot \frac{k \cdot V}{{d}_{p}^{2}} \cdot \frac{{( 1 - ɛ )}^{2}}{{ɛ}^{3}}$$

For a matrix of homogeneous pore structure, pressure drop is directly proportional to the fluid transport length, L, and flux/superficial linear velocity, V. The pressure drop decreases with increasing pore size, dp, and increasing with porosity, ε. Thus, the pore size and porosity are important parameters that affect the pressure drop through the matrix.

Table 2 lists some data derived from results on diesel particulate filters made of Cordierite material. At an air flux of 200 scfh/ft², the pressure drop across the matrix 150 of the microstructure similar to the diesel filter wall is about 0.11 bar at 5 mm transport distance and 0.22 bar at 10 mm distance. If the membrane separation is operated at a pressure gradient of about 5 bar, the pressure drop through the support matrix is only a small fraction. In other words, for a membrane support of a module hydraulic diameter about 10 to 20 mm (Permeation distance about 5 and 10 mm, respectively) and that is operated at about 5 bar pressure gradient, membrane surfaces on all the channels have almost equivalent separation function. Thus, the monolithic membrane support, as taught by the present invention, with a sufficient pressure gradient 170, is workable.

TABLE 2
Projected pressure drop through macroporus ceramic matrix
(based on research results about diesel particulate filter).

| | | | | |
|---|---|---|---|---|
| Flux, mol/(m² · s)* | 0.78 | 0.78 | 0.78 | 0.78 |
| Flux, scfh/ft² | 200 | 200 | 200 | 200 |
| Permeation length, mm | 0.3 | 5 | 10 | 20 |
| Pressure drop, bar | 0.01 | 0.11 | 0.22 | 0.44 |

*The gas flux here is for air at room temperature.

Another critical element the present invention teaches is the balancing of the module diameter. From point of view of flow resistance, the smaller the module diameter, the smaller the pressure drop is through the matrix. From the point of view of handling strength and module installation or membrane system integration, the larger the module diameter, the higher the number of the membrane channels that can be hosted in one module, the easier the system engineering is. However, the pressure drop for the flow to transport from the inner most channel to the outside of the membrane module increases with the module diameter or size. Thus, an optimum module diameter in a range about 10 to 90 mm is preferred.

The inventive membraned support is particularly preferred for separation processes with hydrogen as the permeate. Because hydrogen is the smallest molecule in the hydrogen gas mixture, hydrogen gas would have a larger permeability through the substrate matrix than the other gases.

However, the mixed feedstream 180 could be any other gas-phase stream, and not one forced to contain hydrogen (H₂). But in general, a hydrogen gas mixture can include inorganic gases, such as H₂, CO, CO₂, N₂, H₂O, etc. Other possible constituents in the hydrogen gas mixture could include organic gases, such as hydrocarbons, i.e. CH₄, C₂, H₆, C₂H₄, C₃H₈, CH₃OH, etc.

Alternatively, or included with the gas mixture, the mixed feedstream 180 could be a liquid-phase stream, such as a water-based solution containing other larger components. The larger components can be larger molecules and/or particulates. Thus, a water mixture can have finely-dispersed oil droplets from an industrial waste water stream. Water mixtures can have particulates such as in a beverage juice. Water mixtures can have macro molecules such as proteins. The membraned support is particularly preferred for separation processes with water as the permeate, because water as the smallest molecule the liquid mixture would have a larger permeability through the substrate matrix than the other components.

Moreover, the membraned support is also particularly preferred for separation processes of liquid mixtures involving organic solvents where the organic solvent is the permeate. The liquid-phase stream could be an organic solvent-based solution containing other larger components. For example, an organic solvent mixture can include large homogenous catalyst molecules (e.g., molecular weight>200 Dalton).

Control of the suitable pore size and porosity in the substrate body 150 is critical to the membrane separation performance and module diameter. The larger the pore size and higher the porosity, the less the transport resistance is. However, the pore size and porosity has to be balanced with the requirement of sufficient substrate strength. For the inventive membrane separation process for purifying hydrogen, for example, the substrate 10 is subject to a substantial amount of pressure differential between the inside and outside channel 110, such as about 5 to 30 bar. The pore size of the body matrix 150 is preferably about 0.5 to 20 μm, while the porosity is about 0.2 to about 0.8. The pores are preferred to be interconnected so that a porous network of tortuous paths 152 exists in the substrate 150.

Thus, preferably, the positive pressure gradient 170 which is the pressure differential between the membraned end 1521 and the non-membraned porous body end 1522 of the tortuous path 152 is in a pressure range about 0.6-30 bar and at an operating temperature in a range about 20° to 600° C. The lower pressure gradient of about of 0.1 bar is good for the support 150 only. For the actual separation with the membrane coating applied, a larger delta P is needed. Hence, the pressure range can broaden to a lower limit of 0.1 bar. Specifically, for hydrogen, the separation process is preferably performed at 200 to 600° C. where the material of the substrate or body portion 150 must be stable in the environment of separation gas mixtures at the separation conditions.

Fabrication of the suitable extradite to form the support body 150 of the membrane module 10 is generally known. The monolithic substrate preferably has a module hydraulic diameter 102 of about 10 mm to 50 mm and a module length 104 from about 50 mm to 3000 mm. For handling strength, the large module hydraulic diameter 102 is preferred but the large diameter 102 gives high resistance for a gas, such as a hydrogen gas, to flow through the body portion 150 of the membraned support. A longer module is generally preferred, but the length 104 has to be balanced with the ruggedness of handling and assembling. The substrate 10 has a channel density from 50 to 600 cpsi (cells per square inch) and a channel hydraulic diameter 112 from 0.5 to 3 mm. The high density and small channel size 112 yield a high separation area and thus, is preferred from a separation point of view. However, processing cost may increase with increasing the channel density and decreasing the channel size 112. The channels 110 are preferably distributed over the module cross-section symmetrically but may not need to be distributed uniformly. The arrangement of the channel distribution is determined by mass transport through the membrane 140 and through the substrate matrix 150 which can be simulated by mathematical modeling.

To simplify the number of examples and figures, hydrogen separation out of a gas mixture is often used as a model gas separation system. Functionally in one exemplary use of the membrane module 10, the hydrogen gas mixture 180 comes into the open channel at the feed end 1101 and is split into two streams 1852 and 1802. The hydrogen molecules permeate through the selective membrane 140 on the channel wall 114, diffuse though the module body 150, and come out of the outer surface through the non-membraned porous body end 1522 of the tortuous path 152. The non-hydrogen molecules flow through the channel intact as the byproduct stream 1802.

Functionally, the porous monolith body 150 provides mechanical support and the plurality of tortuous flow paths 152 for the permeated permeate, such as hydrogen gas. The membraned body 150 is a macroporous (>50 nm) matrix preferably consisting of inter-connected tortuous pore paths (0.5˜25 μm) 152. The selective membrane 140 is a micro-porous (<2 nm) coating layer or dense layer that allows hydrogen molecules to go through but retain the non-hydrogen molecules. For example, defect-free Pd or Pd—Ag film is known as an effective selective membrane 140 material. The membrane thickness is about 1 to 10 μm. Optionally, a meso porous intermediate layer 160 (2 to 50 nm) can be coated onto the porous matrix 150 first prior to the Pd film 140 deposition in order to enhance the mechanic strength and Pd adhesion. Thus, the membrane module of the present invention is a macro-, meso-, and micro-structured system. The gas separation only occurs on the dense Pd-based membrane 140 on the channel wall 114, while the porous body 150 provides mechanical support and flow paths 152 of the permeated hydrogen gas. The intermediate layer 160 provides strong interfaces between the membrane film 140 and the support matrix 150.

Preferably for hydrogen, the membrane layer 140 is deposited onto the channel wall 114 and is the place where hydrogen is separated from other molecules, as one exemplary use. In principle, the membrane layer 140 can be any material that can sort hydrogen molecule out of a gas mixture. For example, micro porous materials such as zeolites, dense materials such as Pd and hydrogen ionic conductor can also be used as the membrane layer 140. The Pd-based dense material is preferred for a simple separation process where the Pd material is well known for its excellent hydrogen separation function. The Pd membrane 140 only allows hydrogen molecules to go through while blocking other molecules. The Pd membrane also has high flux. Its performance is further enhanced by using some alloy. However, Pd membrane is an expensive material. For improved separation performance, the thinner the Pd membrane 140, the higher the flux. Thus, to reduce Pd metal cost and obtain a high H₂ flux, the Pd membrane is as thin as possible. The preferred thickness is about 0.5 to 5 μm. The Pd membrane 140 is deposited onto the walls 114 of the channel 110 by using either a chemical vapor deposition method or an electron less plating method.

Thus, operationalwise for hydrogen, the separation process using the membrane module 10 as taught by the present invention includes (1) passing a hydrogen-containing gas mixture 180 into the channel 110 at 5 to 200 bar and 200 to 600° C., (2) letting hydrogen permeate through the membrane 140 and come out of the module external surface 1522 at a pressure gradient of 2 to 30 bar, and (3) letting the remaining gas 1802 flow through the channel 110.

### EXAMPLES

The invention will be further clarified by the following examples.

### Example 1

A monolithic membrane support 150 made of mullite material is made from extruding porous mullite into a circular monolith form. A special circular die was used for the extrusion. The extrusion was performed with two different multi-channel geometries, evenly-distributed 19 channels 110, and evenly-distributed 32 channels 110. The channel size or channel hydraulic diameter 112 is about 1 mm in diameter. The module size is about 1 cm diameter×(20˜30 cm) in length. The pore size and porosity of the resulting mullite membrane supports is shown in Table 3, respectively (measured by the standard mercury porosimetry technique). The single mode of pore size distribution was in a range between about 2-20 μm.

In general, single-mode pore distribution means there is only one peak in the pore size distribution. There could be two or three peaks in the distribution profile. The pore size in this example is only for this case. This single-mode pore size distribution is not necessary. The claimed pore size range more than 20% of the total pore volume having a pore size in a range about 0.5 to 25 um should capture the possible range of pore sizes that is needed to make the current membrane support feasible.

TABLE 3
Properties of Mullite membrane support

| | | Total | |
|---|---|---|---|
| | | Intrusion | Median |
| | | Volume | Pore Diameter |
| # of channels | % porosity | ml/g | um |
| 19 channels | 56.8 | 0.40 | 7.93 |
| 32 channels | 57.4 | 0.41 | 7.72 |

### Example 2

A monolithic membrane support 150 was made from extruding porous α-alumina into circular monolith forms. The plasticized batch was extruded with the extrusion dies as used in Example 1 and the same geometry with the properties listed in Table 4. The resulting monoliths are fairly strong for the gas permeability test.

The membrane support 150 is comprised of an inter-connected, macroporous matrix 150. High membrane surface area and high mechanical strength are obtained by creating many small channels or tortuous paths 152 inside a macroporous body 150 of a larger size as the membrane support. In this example, 19 channels 110 of 1 mm diameter 112 are evenly distributed on a porous alumina body of about 10 mm diameter 102. The nominal wall or web thickness 130 is about 0.7 mm. The support tube has adequate strength for various tests.

TABLE 4
Properties of α-Alumina membrane support

| | | Total | Median |
|---|---|---|---|
| | | Intrusion | Pore |
| Material of monolith | % | Volume | Diameter |
| # of channels 19 | porosity | m/g | um |
| Alumina | 55.7 | 0.32 | 3.98 |

### Example 3

### Comparative

Table 5 shows the dimensions of a monolithic-structured membrane module of channel geometries within the present invention but the matrix pore size beyond the present invention. The substrate, made of γ-alumina material, has a module hydraulic diameter 102 of 9.5 mm and a length 104 of 300 mm.

TABLE 5
Properties of γ-Alumina membrane support

| | | |
|---|---|---|
| Module outer diameter: | 9.5 | mm |
| No. of flow channel: | 19 | |
| Channel diameter: | 1.0 | mm, circular |
| Specific separation area: | 840 | m²/m³(module) |
| Average pore size: | 5.6 | nm |
| Porosity: | 0.50 | cc/g |

### Example 4

### Gas Permeability Tests

Gas permeability was measured with air and He gas to simulate the gas of different molecular sizes. The measurement was conducted at room temperature under steady-state flow conditions in a single-channel configuration, for comparison only of different fluxes between different materials. The single-channel is located at the center of the monolith module. Since the centerline channel is the farthest from the module perimeter, it represents the longest gas path through the module matrix. In other words, if the gas can readily flow from the centerline channel onto the outside of the module, it should not be a problem for the gas to flow out from the channels closer to the perimeter. The gas permeability coefficient, as defined below, is calculated based on the experimental data:

$$V = {k}_{C} \cdot \frac{Δ P}{Δ L}$$

V is the flux, gas flow rate per unit time per unit surface area, cc/cm²/min (or cm/min), ΔP is the pressure drop for the fluid to flow a distance of ΔL. Based on the previous discussion, the permeability coefficient is affected by the pore structure of the support matrix and the fluid properties. The resulting numbers are listed in the following table.

TABLE 6
Permeability coefficient for different substrate material

| | Mullite | | α-alumina | γ-alumina | |
|---|---|---|---|---|---|
| | (Ex. 1) | | (Ex. 2) | (Ex. 3) | |
| | Flow medium | | | | |
| | Air | He | Air | Air | He |
| Coefficient (k), | 10378 | 19825 | 7295 | 1.5 | 3.7 |
| mm · cm/min/bar | | | | | |

*the gas volume rate is the volume under standard condition.

As a convention, the gas flow rate is based on the rate under standard conditions (atmospheric pressure, 20° C.). The permeability coefficient basically is a number to characterize intrinsic permeability of a given material for a given fluid. This number can be used for the membrane module design. The permeability coefficient for He gas is about two times of that for air. This result confirms the preferred application of the module design of present invention that the fraction of smaller molecular sizes in a fluid mixture is preferred to permeate through the membrane and through the matrix. The permeability coefficient for mullite made of the material as in Example 1, and for α-alumina made of the material in Example 2, is about three to four orders of magnitude higher than that for the γ-alumina made of the material in Example 3. The γ-alumina has the similar channel geometries to the mullite and γ-alumina but has very different pore size. The data illustrate that the membrane module geometries of present invention have to be related to the suitable pore size and porosity of the support matrix material.

The permeability coefficient can be used for the scope design of the membrane module. The module diameter is a critical parameter that determines the effectiveness of utilization of all flow channels to achieve the targeted flux. The following table illustrates the variation of flux with the module diameter, projected with the permeability coefficient. It is to be appreciated that the detailed module design can be refined with the computation fluid mechanics or other complicated design tools.

Under a constant ΔP, flux decreases with increasing the module diameter. It is known that for a given module diameter, the flux can be raised by increasing ΔP. However, high ΔP increases the operating and capital cost, and the ΔP also imposes the stringent requirement on the module mechanical strength. For practical operation, a small amount of ΔP across the membrane support is always desired so that large fraction of overall ΔP is applied to the membrane film. Thus, the module diameter has to be designed below a certain size for operation of the membrane separation in a cost-effective and efficient way. For example, for separation of a gas mixture with the permeated gas of similar properties to He gas under overall ΔP of 5 bar, membrane made of the mullite material of module diameter up to 25˜50 mm would be suitable to achieve the targeted flux of 100 cc/min/cm² at 0.1 bar of the ΔP across the support, that is, only 2% of the overall ΔP. At 0.5 bar of the ΔP across the support, that is, 10% of the overall ΔP, the targeted flux may be achieved with the module diameter up to 100 mm.

The membrane module of present invention is preferred for the gas separation over a moderate pressure gradient, about 2 to 25 bar. Thus, the module diameter from 10 to 100 mm is preferred with the support material of the gas permeability as the mullite and α-alumina, illustrated in this example.

TABLE 7
Gas flux through monolith membrane support of different diameter

Module diameter, mm

| | 10 | 25 | 50 | 100 |
|---|---|---|---|---|
| Flux at 0.1 bar ΔP | | | | |
| Mullite | | | | |
| Air, cc/cm²/min | 208 | 83 | 42 | 21 |
| He, cc/cm²/min | 396 | 159 | 79 | 40 |
| α-alumina | | | | |
| Air, sccm/cm2 | 146 | 58 | 29 | 15 |
| Flux at 0.5 bar ΔP | | | | |
| Mullite | | | | |
| Air, cc/cm²/min | 1040 | 415 | 210 | 105 |
| He, cc/cm²/min | 1980 | 779 | 395 | 200 |
| α-alumina | | | | |
| Air, sccm/cm2 | 730 | 290 | 145 | 75 |

### Example 5

Gas permeability was measured in a multi-channel configuration of the monolithic support. In this example, SiC monolithic support made for diesel particulate filter application was core-drilled into 10 mm diameter and 150 mm in length. The partial channels around the periphery were plugged so that the module had sixteen full channels of 1.1 mm in square shape with the wall thickness between the adjacent channels of 0.34 mm. As a comparison, γ-alumina monolith made for the catalyst support application of the similar size was also tested. In this measurement, the feed gas was introduced into all the open channels and came out of the external body of the support. The gas permeation rate was measured with air and helium gas under a constant pressure differential. Flux was calculated by dividing the total gas permeation rate with the channel surface area that was exposed to the feed gas. The permeance number is calculated based on the experimental data by the following equation:

$$P = \frac{flux}{Δ P}$$

TABLE 8
Permeance of different substrate material

| | |
|---|---|
| SiC | |
| (diesel | γ-alumina |
| particulate | (catalyst |
| filter) | support) |

| Flow medium | Air | He | Air | He |
|---|---|---|---|---|
| Permeance, cc/min/cm²/bar | 1973 | 2718 | 2.7 | 6.6 |

*the gas volume rate is the volume under standard condition.

Consistent with the single-channel permeability test in Example 4, the permeance for He gas is higher than that for air. The permeance through the SiC monolith is about three orders of magnitude higher than through the γ-alumina. The SiC monolith was purposely prepared for a pore size about 1 to 10 μm for particulate filtration application in the diesel vehicle exhaust gas, while the γ-alumina monolith of pore size from 5 to 12 nm was purposely prepared as the catalyst support. The example clearly shows that the membrane module design of present invention is feasible with the support material of suitable pore size.

It is noted that the permeance number used in this example is a global parameter for comparison of the whole module permeability only. By contrast, the permeability coefficient measured in Example 4 characterizes the intrinsic permeability of the support material and is a important input number for the membrane module design.

It is also noted that though the SiC and y-alumina monolith was for respective non-membrane application, the permeation test was conducted by configuring them into the membrane module of the present invention.

### Example 6

### Liquid Permeability Test

Liquid permeability test was performed with de-ionized water with the mullite support of the pore structure as prepared in Example 1. Water was introduced into the centerline channel of the module and permeated through the support under a positive pressure gradient at room temperature. The water gas permeability coefficient was calculated based on the experimental data. The resulting permeability coefficient is 87.4 mm·cm/min/bar.

This permeability coefficient can be used for scope design of the module diameter for the water filtration process.

TABLE 9
Water flux through monolith membrane support of different diameter

| | Module diameter, mm | | | |
|---|---|---|---|---|
| | 10 | 25 | 50 | 100 |
| Water flux at ΔP = 0.1 bar, cc/min/cm² | 1.75 | 0.70 | 0.35 | 0.17 |

For example, for a liquid-phase separation process with water as the permeate, if targeted water flux is 100 L/m2/h (or 0.17 cc/min/cm2) under overall ΔP=1 bar between the feed inside the channel and the permeate outside of the membrane module, the membrane module made of the material of the pore structure same as the mullite of Example 1 is feasible for the module diameter up to about 100 mm at 0.1 bar of ΔP across the support, that is, 10% of overall ΔP. If the smaller fraction of the overall ΔP or larger flux is desired, the smaller module diameter needs to be chosen. This example illustrates the feasibility of the membrane module support of present invention for the water filtration application.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A ceramic monolithic multi-channel module support having a module hydraulic diameter in a range about 9 to 100 mm, an aspect ratio of the module hydraulic diameter to a module length greater than 1, a plurality of feed flow channels distributed substantially in parallel over a module cross-section, the plurality of feed flow channels having a size and shape defining a channel density in the range of about 50-800 channels/in² (7.8-124 channels/cm²) in a module frontal area, a channel hydraulic diameter in the range of about 0.5-3 mm, a rim distance having a thickness greater than 1.0 mm (0.04 in), and a percent open frontal area (OFA) in the range of about 20-80%.

2. The module of claim 1, wherein the module length is substantially equal to the length of the plurality of feed flow channels being in a range about 100-3000 mm.

3. The module of claim 1, wherein the ceramic monolithic multi-channel module support has more than 20% of the total pore volume having a pore size in a range about 0.5 to 25 um.

4. The module of claim 3, wherein the ceramic monolithic multi-channel module support is made from a member selected from the group consisting of mullite (Al₂O₃-SiO₂), alumina (Al₂O₃), silica (SiO₂), cordierite (2MgO-2Al₂O₃-5SiO₂), silicon carbide (SiC), alumina-silica mixture, glasses, inorganic refractory and ductile metal oxides.

5. The module of claim 4, wherein the member comprises α-alumina.

6. The module of claim 4, wherein the member comprises γ-alumina.

7. The module of claim 4, wherein Vycor® glass.

8. The module of claim 1, further comprising a membrane film disposed on the inner surfaces of the plurality of feed flow channels, wherein the inorganic film is a member selected from the group consisting of palladium, palladium-alloy, Pd—Ag, Pd—Cu, zeolite, alumina, zirconia, silica, SiC, glass, and polymer.

9. The module of claim 8, further comprising an intermediate layer disposed between the membrane film and the inner surfaces of the plurality of feed flow channels, wherein the intermediate layer has a thickness in a range about 2-250 μm and a pore size in a range about 2 nm-500 nm and is a member selected from the group consisting of alumina, silica, zirconia, and a mixture thereof.

10. The module in accordance with claim 1, having a module hydraulic diameter in a range about 10 to 50 mm, an aspect ratio of the module hydraulic diameter to a module length greater than a range about 5-10, a plurality of feed flow channels distributed in parallel over a module cross-section, the plurality of feed flow channels having a size and shape defining a channel density in the range of about 50-600 channels/in² (7.8-94 channels/cm²) in a module frontal area, a channel hydraulic diameter in the range of about 0.5-2 mm, a web thickness between channel walls less than the rim distance in a range about 0.2 to 5 mm (0.01 to 0.2 in), and a percent open frontal area (OFA) in a range about 30-60%.

11. A ceramic monolithic multi-channel membrane module comprising:
a support comprising:
a porous body portion having a module hydraulic diameter in a range about 10 to 50 mm, an aspect ratio of the module hydraulic diameter to a module length greater than 1; and
a plurality of feed flow channels in a channeled portion distributed in parallel over a module cross-section having a channel density in the range of about 50-800 channels/in² (7.8-124 channels/cm²) in a module frontal area, a channel hydraulic diameter in the range of about 0.5-3 mm, and a percent open frontal area (OFA) in the range of about 20-80%; and
a membrane film disposed on the inner surfaces of each of the plurality of feed flow channels.

12. The module of claim 11, wherein the porous body portion comprises a macro-porous matrix.

13. The module of claim 12, wherein the membrane film comprises a nano-porous layer coated over a micro-porous layer.

14. A ceramic monolithic multi-channel processing membrane module comprising:
a support comprising:
a porous body portion having a module hydraulic diameter in a range about 10 to 50 mm, an aspect ratio of the module hydraulic diameter to a module length greater than 1, and a plurality of tortuous paths through the matrix of the porous body portion having a membraned end and a non-membraned porous body end; and
a plurality of feed flow channels having a feed end and an exhaust end, the plurality of feed flow channels forming a channeled portion distributed in parallel over a module cross-section having a channel density in the range of about 50-800 channels/in² (7.8-124 channels/cm²) of a module frontal area, a channel hydraulic diameter in the range of about 0.5-3 mm, and a percent open frontal area (OFA) in the range of about 20-80%; and
a membrane film disposed on the channel walls of each of the plurality of feed flow channels, the membrane film is supported and adapted to receive under a positive pressure gradient, an impure mixed feedstream fed on the feed end of the plurality of feed flow channels, wherein the membrane film is adapted to process the impure mixed feedstream into a purified permeate that is formed from a portion of the impure mixed feedstream that passes through an outside surface of the membrane film and into the plurality of tortuous paths of the matrix of the body portion, entering the membraned end and exiting through the non-membraned porous body end, and a byproduct stream remaining from a portion of the impure mixed feedstream that does not pass through the membrane film for exhausting through the exhaust end of the plurality of feed flow channels.

15. The module of claim 14, wherein the mixed feedstream comprises a gas-phase stream.

16. The module of claim 15, wherein the gas-phase stream includes hydrogen.

17. The module of claim 14, wherein the mixed feedstream comprises a liquid-phase stream.

18. The module of claim 17, wherein the liquid-phase stream comprises a water-based solution containing other larger components.

19. The module of claim 17, wherein the liquid-phase stream comprises an organic solvent-based solution containing other larger components.

20. The module of claim 14, wherein the positive pressure gradient comprises a pressure differential between the membraned end and the non-membraned porous body end of each of the tortuous paths is in a pressure range about 0.1-30 bar and at an operating temperature in a range about 20° to 600° C.
